(19) United States
(12) Patent Application Publication
(10) Pub. No.: US 2012/0042278 A1
(43) Pub. Date: Feb. 16, 2012

(54) METHOD AND APPARATUS FOR PROVIDING A USER WITH SELECTIVE CONTROL OVER SCROLLING FUNCTIONS

(75) Inventor: Matti Vaisanen, Helsinki (FI)

(73) Assignee: Nokia Corporation

(21) Appl. No.: 12/854,467

(22) Filed: Aug. 11, 2010

(51) Int. Cl. G06F 3/048; G06F 3/033

(52) U.S. Cl. 715/786; 715/863

(57) ABSTRACT

A method for providing a scrolling mechanism may include receiving an indication of a stroke event at a display generating a content view of at least a portion of a content page, classifying the stroke event based on characteristics of the stroke event, and determining whether to generate a scroll enhancement on the display based on a classification of the stroke event. The stroke event may initiate scrolling over the content page to alter the content view. A corresponding apparatus and computer program product are also provided.

### TECHNOLOGICAL FIELD

Some example embodiments of the present invention relate generally to user interface technology and, more particularly, relate to a method and apparatus for providing a scrolling mechanism.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

### BRIEF SUMMARY

A method, apparatus and computer program product are therefore provided for providing a scrolling mechanism. In particular, a method, apparatus and computer program product are provided that may enable the user to have selective control over scrolling over large distances. Thus, for example, the user's input may be interpreted and scrolling operations may be undertaken with the additional provision of scroll enhancements such as scrolling shortcuts and/or sliders being presented (e.g., in a semi-transparent form) in situations in which the user's intent can be interpreted as desiring such scroll enhancements.

In one example embodiment, a method of providing a scrolling mechanism is provided. The method may include receiving an indication of a stroke event at a display generating a content view of at least a portion of a content page, classifying the stroke event based on characteristics of the stroke event, and determining whether to generate a scroll enhancement on the display based on a classification of the stroke event. The stroke event may initiate scrolling over the content page to alter the content view.

In another example embodiment, a computer program product for providing a scrolling mechanism is provided. The computer program product may include at least one computer-readable storage medium having computer-executable program code instructions stored therein. The computer-executable program code instructions may include program code instructions for receiving an indication of a stroke event at a display generating a content view of at least a portion of a content page, classifying the stroke event based on characteristics of the stroke event, and determining whether to generate a scroll enhancement on the display based on a classification of the stroke event. The stroke event may initiate scrolling over the content page to alter the content view.

In another example embodiment, an apparatus for providing a scrolling mechanism is provided. The apparatus may include at least one processor and at least one memory including computer program code. The at least one memory and the computer program code may be configured to, with the at least one processor, cause the apparatus at least to perform receiving an indication of a stroke event at a display generating a content view of at least a portion of a content page, classifying the stroke event based on characteristics of the stroke event, and determining whether to generate a scroll enhancement on the display based on a classification of the stroke event. The stroke event may initiate scrolling over the content page to alter the content view.

In another example embodiment, an apparatus for providing a scrolling mechanism is provided. The apparatus may include means for receiving an indication of a stroke event at a display generating a content view of at least a portion of a content page, means for classifying the stroke event based on characteristics of the stroke event, and means for determining whether to generate a scroll enhancement on the display based on a classification of the stroke event. The stroke event may initiate scrolling over the content page to alter the content view.

Some embodiments of the invention may provide a method, apparatus and computer program product for improving user interface performance. As a result, for example, mobile terminal users may enjoy improved capabilities with respect to web browsing and other services or applications that may be used in connection with a touch screen or other display.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 is a schematic block diagram of an apparatus for providing a scrolling mechanism according to an example embodiment of the present invention;

FIG. 3 illustrates a content view showing a portion of an example web page which may be scrolled according to an example embodiment of the present invention;

FIG. 4 illustrates a content view being scrolled over horizontally according to an example embodiment of the present invention;

FIG. 5 illustrates a content view being scrolled over vertically according to another example embodiment of the present invention; and

FIG. 6 is a block diagram according to an example method for providing a scrolling mechanism according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

In many situations, it may be desirable for the user to interface with a device such as a mobile terminal for the provision of an application or service. A user's experience during certain applications such as, for example, web browsing may be enhanced by using a touch screen display, a cursor or mouse, a joystick or numerous other mechanisms as the user interface.

In certain environments, such as when used in connection with a mobile terminal or other device having a relatively small display, scrolling may be an important part of the user interface. In this regard, for example, when a web page or a document is displayed on a device having a relatively small display, it is common for only a portion of the web page or document to be displayed, with remaining portions of the web page or document being accessible by scrolling. Common mechanisms for scrolling in such situations have included kinetic panning and interactive scroll bars (or slider bars) and/or indicative scroll bars. The interactive scroll bars are constantly visible and, in many situations, include separate scroll bars to permit scrolling in cardinal directions (e.g., the four primary directions with respect to the display such as up, down, left and right). Indicative scroll bars are only displayed while a document is moving. Kinetic panning may involve the sensing of user activity such as a flick or drag on a touch screen or other display screen and then implementing scrolling based on the direction and relative strength of the flick or drag action.

As indicated above, some embodiments of the present invention may relate to the provision of selective user control over scrolling functions. Some example embodiments may provide interactive scroll bars that are not necessarily continuously visible and that therefore may not unnecessarily inhibit the view of certain portions of the display. Moreover, some example embodiments in which the interactive scroll bars are optimized for finger-use such that they may be oversized and would otherwise further inhibit the view of portions of the display may be modified to reduce the impact on the display screen.

To improve the capabilities of users with respect to scrolling in a manner that provides flexibility for scrolling while mitigating the impact on the content displayed, some example embodiments provide for selective presentation of scrolling enhancements. The scrolling enhancements may not be displayed in situations where the user's actions indicate that the user is relatively close to the area of interest, but may be displayed when it appears as though the user is intending to scroll over a relatively large area. The scrolling enhancements may therefore be presented to enable the user to implement scrolling shortcuts or to utilize a slider (e.g., a semi-transparent slider) to increase the speed and/or efficiency of scrolling.

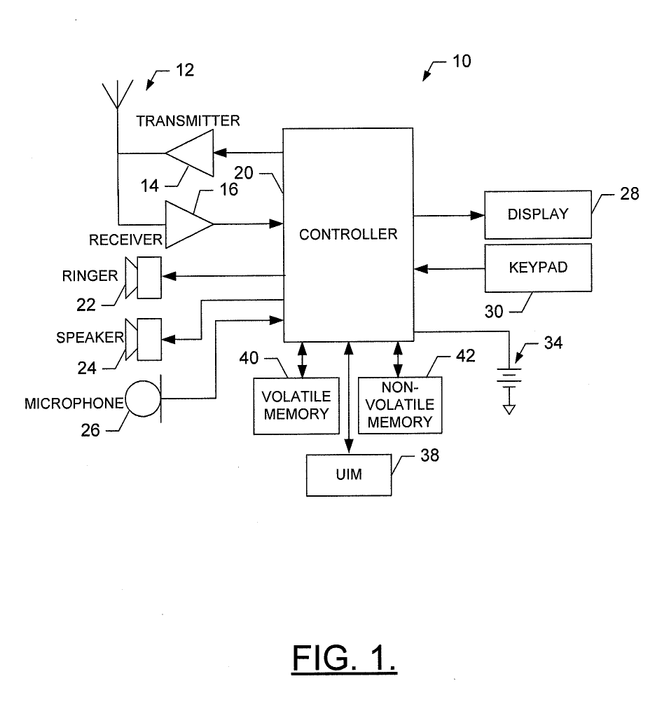

FIG. 1, one example embodiment of the invention, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, video recorders, audio/video players, radios, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

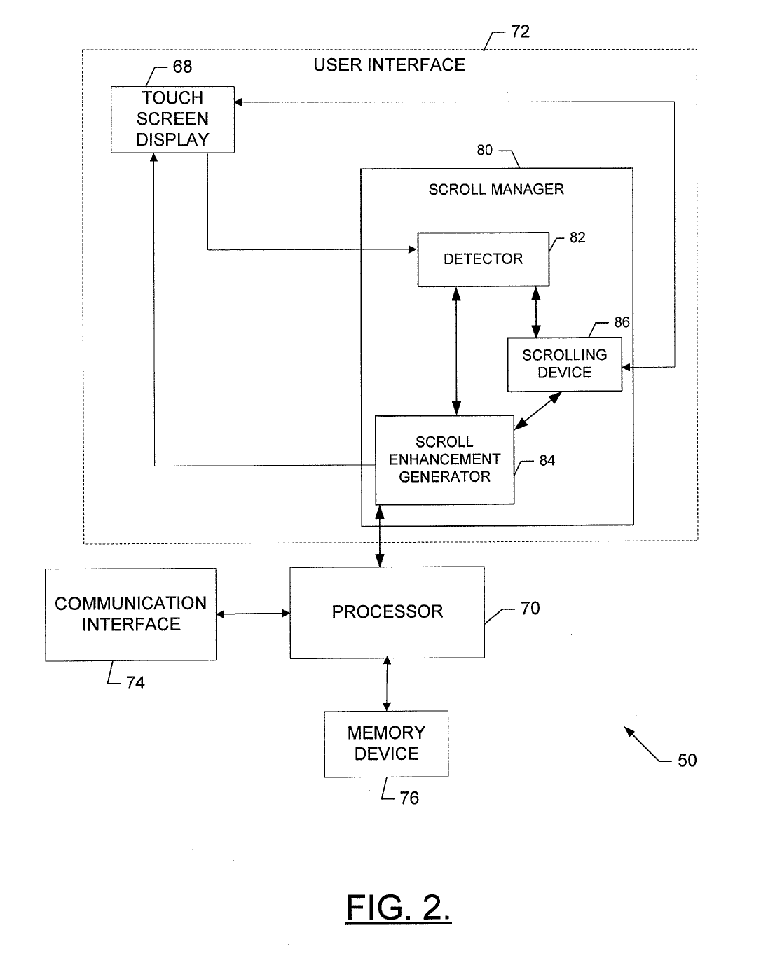

The mobile terminal 10 may include an antenna 12 (or multiple antennas) in operable communication with a transmitter 14 and a receiver 16. The mobile terminal 10 may further include an apparatus, such as a controller 20 or other processing device (e.g., processor 70 of FIG. 2), which provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the controller 20 may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (of which display 28 may be an example in some instances and therefore no other display may necessarily be needed) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

An example embodiment of the invention will now be described with reference to FIG. 2, in which certain elements of a system for providing a scrolling mechanism for touch screen devices are displayed. The system of FIG. 2 may be employed, for example, in conjunction with the mobile terminal 10 of FIG. 1. However, it should be noted that the system of FIG. 2, may also be employed in connection with a variety of other devices, both mobile and fixed, and therefore, embodiments of the present invention should not be limited to application on devices such as the mobile terminal 10 of FIG. 1. It should also be noted that while FIG. 2 illustrates one example of a configuration of a system for providing a scrolling mechanism for touch screen devices, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element. Moreover, although an example embodiment of the present invention described below will generally refer to scrolling in the context of a web browsing application (e.g., scrolling over a portion of a web page), embodiments of the present invention more generally relate to scrolling over any page, document, screen, etc. over which only a portion of such page, document, screen, etc. may be displayed at a given time.

Referring now to FIG. 2, an apparatus 50 for providing a scrolling mechanism for touch screen devices is provided. The apparatus 50 may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein. In such an embodiment, for example, the apparatus 50 may include only the processor 70 and the memory device 76 storing instructions that when executed by the processor 70 carry out the functionalities described herein.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28). The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, etc. techniques. The user interface 72 may be in communication with the touch screen display 68 to receive indications of user inputs at the touch screen display 68 and to modify a response to such indications based on corresponding user actions that may be inferred or otherwise determined responsive to the indications.

In an example embodiment, the apparatus 50 may include a scroll manager 80. The scroll manager 80 may, in some instances, be a portion of the user interface 72. However, in some alternative embodiments, the scroll manager 80 may be embodied as the processor 70 or may be a separate entity controlled by the processor 70. As such, in some embodiments, the processor 70 may be said to cause, direct or control the execution or occurrence of the various functions attributed to the scroll manager 80 as described herein. The scroll manager 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the scroll manager 80 as described herein. Thus, in examples in which software is employed, a device or circuitry (e.g., the processor 70 in one example) executing the software forms the structure associated with such means.

The scroll manager 80 may be configured to receive an indication of an input in the form of a touch event at the touch screen display 68. Following recognition of the touch event, the scroll manager 80 may be configured to thereafter classify the touch event to determine a stroke as, for example, a flick or drag event and provide a corresponding scroll function and/or scroll enhancements based on the touch event classification determined. In some cases, a drag operation may be determined in situations in which an object (e.g., a finger) is in contact with the touch screen display 68 while the object is moved from one place to another and then the object is lifted. In other words, the object is in contact with the touch screen display 68 throughout the movement of the object. Meanwhile, a flick may be determined in situations in which the object is not stopped before the object is lifted out of contact with the touch screen display 68. The length and velocity of the flick generally determine the relative strength of the flick.

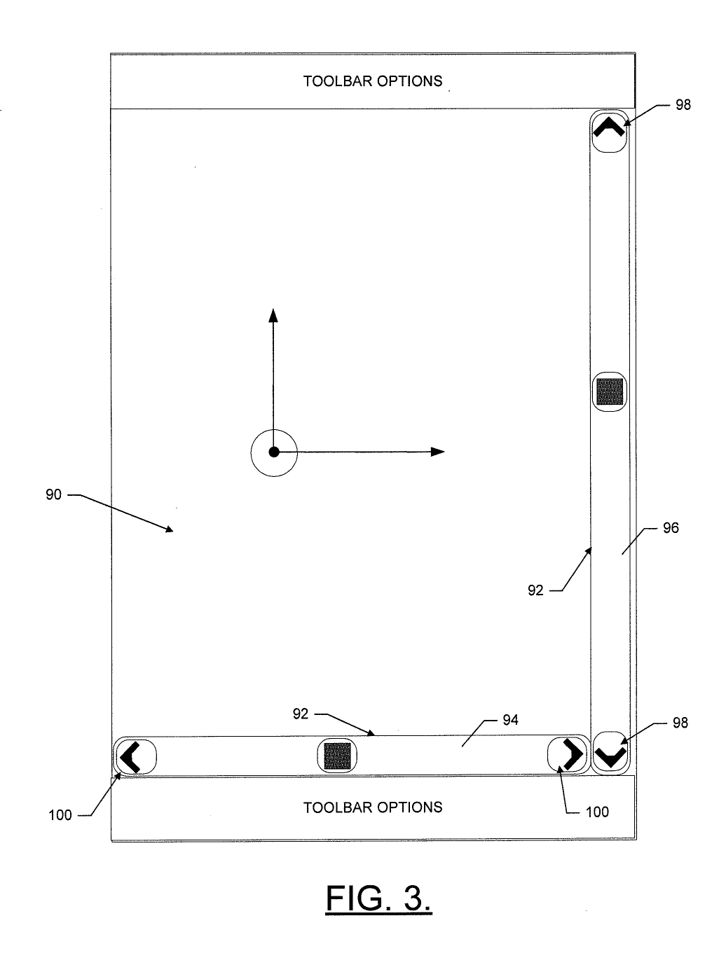

In an example embodiment, the scroll manager 80 includes a detector 82, a scroll enhancement generator 84 and a scrolling device 86. Each of the detector 82, the scroll enhancement generator 84 and the scrolling device 86 may be any device or means embodied in either hardware, or a combination of hardware and software configured to perform the corresponding functions associated with the detector 82, the scroll enhancement generator 84 and the scrolling device 86, respectively, as described below. In an example embodiment, each of the detector 82, the scroll enhancement generator 84 and the scrolling device 86 may be controlled by or otherwise embodied as the processor 70. Elements of the scroll manager 80 will now be described in reference to FIGS. 2 and 3. FIG. 3 illustrates a content view 90 showing a portion of an example web page (or page) which may be scrolled over in connection with an example embodiment of the present invention. Although the content view 90 does not cover the entirety of the display in this example, the content view 90 may cover the entire display in some embodiments. In situations where the content view 90 does not cover the entire display, other features such as toolbar options may cover the portions of the display that are not covered by the content view 90.

The detector 82 may be in communication with the touch screen display 68 to receive indications of user inputs in order to recognize and/or determine a touch event based on each input received at the detector 82. A touch event may be defined as a detection of an object, such as a stylus, finger, pen, pencil or any other pointing device, coming into contact (or coming within proximity to a predefined distance) with a portion of the touch screen display in a manner sufficient to register as a touch. In this regard, for example, a touch event could be a detection of pressure on the screen of touch screen display 68 above a particular pressure threshold over a given area. Subsequent to each touch event, the detector 82 may be further configured to recognize and/or determine a corresponding stroke event. In other words, the detector 82 may be configured to classify a stroke event. A stroke event may be defined as a touch event followed immediately by motion of the object initiating the touch event while the object remains in contact with the touch screen display 68. In other words, the stroke event may be defined by motion following a touch event thereby forming a continuous, moving touch event defining a moving series of instantaneous touch positions (e.g., as a drag operation or as a flick operation). As such, dependent upon characteristics of the stroke event (e.g., length of movement, direction of movement, touch pressure, touch intensity and/or speed of movement of the object), the detector 82 may classify the stroke event accordingly. The classifications may be made relative to various thresholds or ranges of lengths, directions and/or speeds of movement.

Although an example embodiment is described above in relation to a touch screen, it should be appreciated that some embodiments may be practiced in connection with conventional screens wherein a mouse or other scrolling tool is employed and in such a situation a stroke event may relate to an action initiated by the scrolling tool that may not involve a touching of the screen.

For purposes of the description above, the term immediately should not necessarily be understood to correspond to a temporal limitation. Rather, the term immediately, while it may generally correspond to relatively short time after the touch event in many instances, instead is indicative of no intervening actions between the touch event and the motion of the object defining the touch position 68 while such object remains in contact with the touch screen display 68. However, in some instances in which a touch event that is held for a threshold period of time triggers a corresponding function, the term immediately may also have a temporal component associated in that the motion of the object causing the touch event must occur before the expiration of the threshold period of time.

In an example embodiment, the detector 82 may be configured to communicate detection information regarding the recognition, detection and/or classification of a stroke event to the scroll enhancement generator 84 and/or the scrolling device 86. The scrolling device 86 may be configured to initiate scrolling of the content view 90 based on the stroke event. For example, if the user enters a stroke event defining a drag operation to the left, the scrolling device 86 may be configured to move the view window presented with respect to the document or page being viewed in the content view 90 to the right. In other words, dragging a portion of the page to the left enables further viewing of content to the right (and vice versa). Similarly, dragging a portion of the page up enables viewing of additional content that is located in the downward direction. Whether responding to a drag or a flick (where the amount of scrolling is proportional to the magnitude of the flick operation), the direction of the drag or flick causes a shift of the viewing window of the content view 90 toward the opposite direction. Thus, the scrolling device 86 may be configured to support scrolling directly responsive to the user input defined by the stroke event.

In some embodiments, however, it may be desirable to enable the user to have selective control over enhancing the normal scrolling function. To provide such selective control, the scroll enhancement generator 84 may be configured to enable the generation of scroll enhancements in situations where such enhancements are desirable. To determine the situations in which scroll enhancements are desired, some embodiments of the present invention may infer user intent from the classification of the stroke event. For example, a relatively small magnitude stroke event may be used to infer that the user is close to capturing his or her intended target object or objects in the content view 90. However, a relatively large magnitude stroke event may be used to infer that the user is not close to capturing his or her intended target object or objects in the content view 90 and thus a scroll enhancement may be useful.

Accordingly, in some embodiments, in response to receipt of the detection information, the scroll enhancement generator 84 may generate a scroll enhancement based on the classification of the stroke event. For example, in some cases where the stroke event is determined to correspond to a relatively minor repositioning of the page (e.g., a relatively small, short or slow drag or flick operation and/or a single event), the scroll enhancement generator 84 may not generate any scroll enhancement as the user may already be relatively nearby the intended object or objects of the scrolling. However, for example, if the stroke event is determined to correspond to a relatively major (or at least not minor) repositioning of the page (e.g., as indicated by the length, size and/or speed of flick operation or repetition of a flick (or perhaps even repeated drag operations)), the scroll enhancement generator 84 may generate at least one scroll enhancement 92 for depositing on the content view 90. The scroll enhancement 92 may be one or more slider bars/scroll bars (e.g., horizontal scroll bar 94 or vertical scroll bar 96) or shortcuts (e.g., up/down shortcuts 98 or right/left shortcuts 100 that may either advance a single page or advance to the edge of the document in the corresponding direction). In some embodiments, the scroll enhancements 92 may be generated to be semi-transparent such that content behind the scroll enhancements is still visible through the scroll enhancements. In some cases, the slider bars/scroll bars that are typically displayed when a panning operation is underway are not interactive, but indicate where the current view of the document is relative to the total document size. However, in some example embodiments, the slider bars/scroll bars (e.g., horizontal scroll bar 94 or vertical scroll bar 96) that are presented in connection with the scroll enhancement 92 may be interactive. As such, the horizontal scroll bar 94 or vertical scroll bar 96 may, when displayed, be semi-transparent, enlarged in size and/or otherwise presented in some other distinguishing manner with respect to a conventional indicative scroll bar to facilitate use with a finger for enhanced scrolling control when scroll enhancement is triggered.

Accordingly, the content view 90 may initially be presented with or without any scroll bars or shortcuts. In response to a stroke event, a determination may be made as to the classification of the stroke event. If the stroke event is classified as a drag event or a minor flick event (e.g., a flick event having a low velocity and/or small length (as determined relative to corresponding thresholds)), the scroll enhancement generator 84 may not generate any scroll enhancements. However, if the stroke event is classified as a major flick event (e.g., a flick event having a high velocity and/or long length (as determined relative to corresponding thresholds)), the scroll enhancement generator 84 may generate at least one scroll enhancement. In situations where repeated drag events or repeated minor flick events are encountered, the scroll enhancement generator 84 of some example embodiments may also generate at least one scroll enhancement.

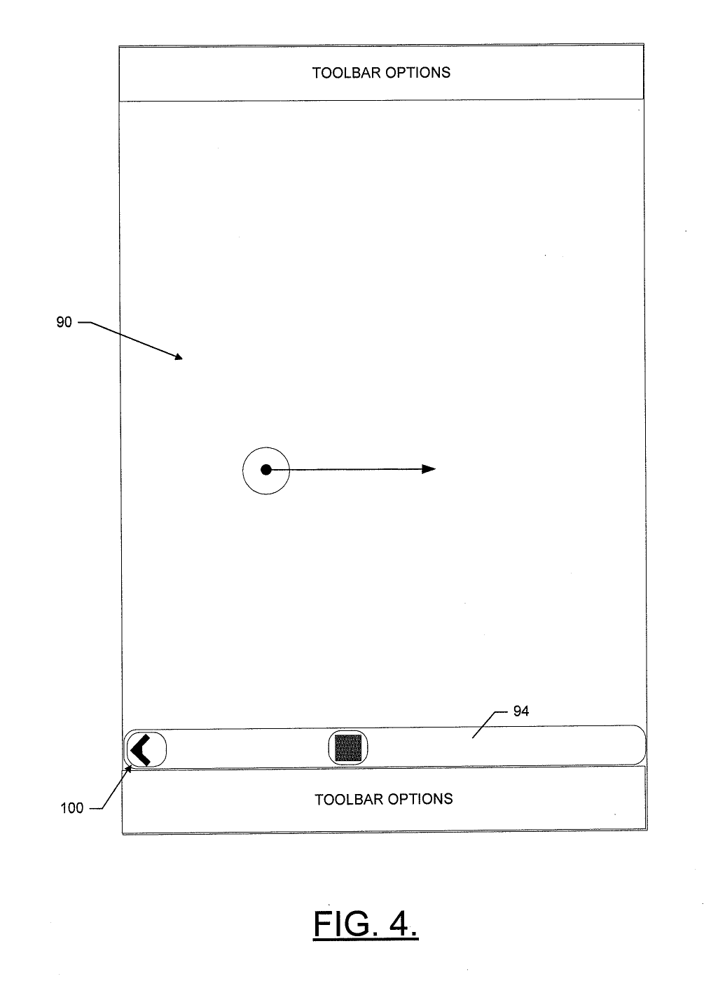

In some embodiments, the scroll enhancement generator 84 may determine the direction of the stroke event in order to determine whether to provide scroll enhancements oriented horizontally or vertically (and perhaps diagonally as well in some cases). For example, if the direction of a stroke event is to the right, and a scroll enhancement is otherwise appropriate based on the classification (e.g., the velocity and length (and/or frequency)) of the stroke event, the scroll enhancement generator 84 may present only the horizontal scroll bar 94 and/or only a left side of the right/left shortcuts 100 (although in some embodiments, both the right and left sides of the right/left shortcuts 100 may be presented). FIG. 4 illustrates an example of a possible display produced responsive to operation of the scroll enhancement generator 84 during a scrolling operation following a stroke event to the right. However, it should be noted that non-interactive scroll indicators may be included (e.g., in both horizontal and vertical directions) in some cases as well although they are not specifically shown in FIG. 4.

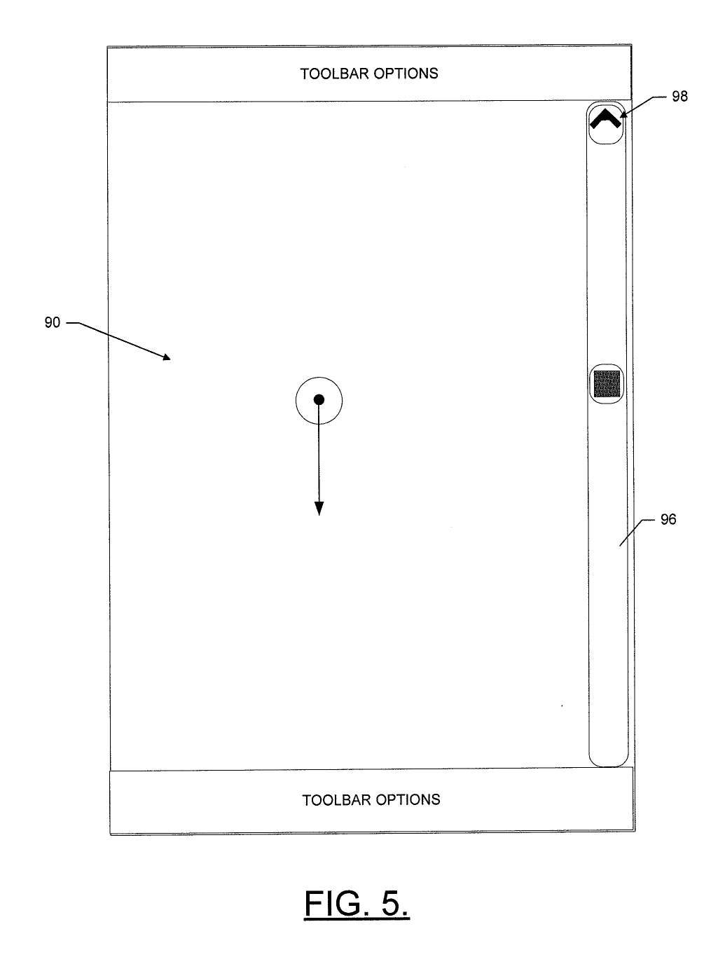

Meanwhile, again as an example, if the direction of a stroke event is downward, and a scroll enhancement is otherwise appropriate based on the classification (e.g., the velocity and length (and/or frequency)) of the stroke event, the scroll enhancement generator 84 may present only the vertical scroll bar 96 and/or only the up oriented one of the up/down shortcuts 98 (although in some embodiments, both the up and down oriented sides of the up/down shortcuts 98 may be presented). FIG. 5 illustrates an example of a possible display produced responsive to operation of the scroll enhancement generator 84 during a scrolling operation following a downward oriented stroke event. However, it should be noted that non-interactive scroll indicators may be included (e.g., in both horizontal and vertical directions) in some cases as well although they are not specifically shown in FIG. 5.

If the direction of the stroke event is diagonal (e.g., has a component of at least a threshold amount in both vertical and horizontal directions), the scroll enhancement generator 84 may be configured to present either or both of the vertical scroll bar 96 in combination with the horizontal scroll bar 94 and one or more of the up/down shortcuts 98 in combination with one or more of the right/left shortcuts 100.

In some embodiments, the vertical scroll bar 96 and the up/down shortcuts 98 may be presented on the right side (e.g., at the right edge) of the touch screen display 68 in order to minimize interference with or obstruction of the content view 90. However, the scroll enhancement generator 84 may be configured to generate the vertical scroll bar 96 and the up/down shortcuts 98 at the left side (e.g., at the left edge) or at any other suitable portion of the content view 90 as well. Similarly, the horizontal scroll bar 94 and the right/left shortcuts 100 may be presented on the bottom side (e.g., at the bottom edge) of the touch screen display 68 in order to minimize interference with or obstruction of the content view 90. However, the scroll enhancement generator 84 may be configured to generate the horizontal scroll bar 94 and the right/left shortcuts 100 at the top side (e.g., at the top edge) or at any other suitable portion of the content view 90 as well. For example, the scroll enhancements 92 may be generated at a point close to where the touch event begins or ends. A size of the scroll enhancements 92 may be standard in some cases (e.g., extending over the length and/or width of the screen, respectively). However, in some embodiments, the size of the scroll enhancements 92 may depend upon the object used on the touch screen display 68. For example, smaller or thinner scroll enhancements 92 may be generated in response to a determination that the object used for interaction with the touch screen display 68 is a stylus or other object with a relatively sharp point, while larger or wider scroll enhancements 92 may be generated in response to a determination that the object used for interaction with the touch screen display is a finger.

As indicated above, the scroll enhancements 92 may generally be presented as semi-transparent objects on the touch screen display 68. However, in some embodiments, the scroll enhancement generator 84 may be configured to generate the scroll enhancements only when the document or page is moving. In other words, while the scrolling device 86 is moving the document responsive to a major flick operation, the scroll enhancement generator 84 may present the user with the scroll enhancements 92 to enable to user to use the scroll bars for rapid scrolling or to use the shortcuts to rapidly advance pages or reach an end of the document. Thus, for example, in some embodiments the scroll enhancements 92 may be removed as soon as the scrolling device 86 stops moving the page or document and the content view 90 becomes stable on a particular portion of the page or document. Once the scroll enhancements 92 are displayed, the user can interact with them or choose not to interact with them as desired. However, functionality with respect to the remainder of the content view 90 is unaltered. Thus, for example, if a major flick operation is initiated and the scrolling device 86 begins to rapidly scroll over the page based on the strength of the flick operation, although the scroll enhancements 92 may be presented, the user may still tap on the content view 90 (e.g., apart from the scroll enhancements 92) in order to stop the scrolling action, or activate another object by tapping. As such, the scrolling enhancements 92 do not block user interaction with the document, but rather enhance user interaction with the document.

In some cases, the scroll enhancements 92 may be provided in connection with a timer. For example, when the scroll enhancement generator 84 presents a scroll enhancement, a timer may either begin to count up or down. The scroll enhancements 92 may, once initially generated, continue to be generated at least until the timer expires (e.g., counts up or down to a predetermined value). As such, for a relatively short scroll operation including a flick action that triggers generation of a scroll enhancement, but then ends very quickly (or a series of such operations), the scroll enhancement generator 84 will not cycle quickly through turning the scroll enhancement on and off. Instead, the timer will be allowed to expire first so that if an additional stroke event occurs during the timer run, the scroll enhancement will be maintained, or if no additional stroke event occurs at least the scroll enhancement will not appear to flicker on and off in a distracting manner. If the scroll enhancement is otherwise presented for a period that exceeds the timer run, the timer may have no impact on removal of the scroll enhancement. However, in some embodiments, scroll enhancement removal may always occur after a period including the time period during which the document is moving with additional delay added for the timer run. In other words, the timer run could start when movement of the document stops in some embodiments rather than when movement of the document starts.

Some embodiments of the present invention may therefore enable display of a graphical user interface that is adapted to the current use case. As such, a finger-usable graphical interface for selectively enhancing scrolling may be presented to occupy space modifying the content view only when it can be determined (based on the user's actions) that the user's intent suggests the appropriateness of selectively presenting scroll enhancement options. The graphical user interface may be invoked naturally using already familiar stroke operations on a touch screen display, but may be hidden otherwise. Fast scrolling may therefore be selectively enabled without the user having to make any special additional effort to enable (or disable) such a feature.

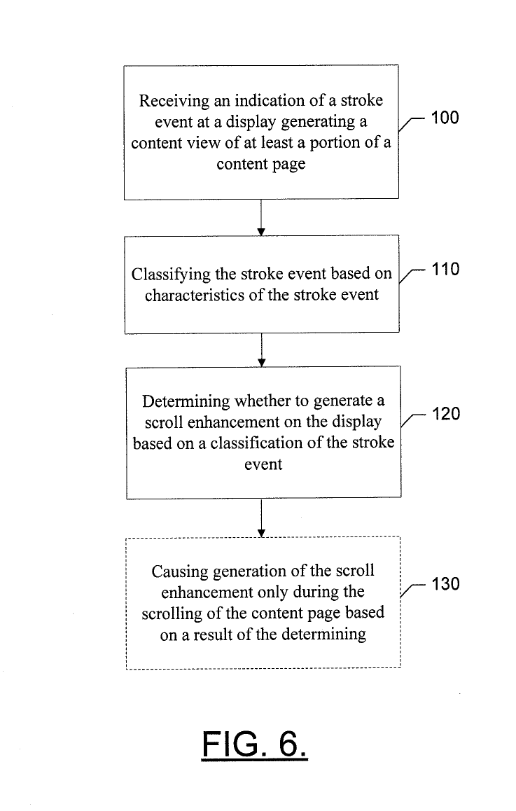

FIG. 6 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 6, may include receiving an indication of a stroke event (e.g., at a touch screen display or other display) generating a content view of at least a portion of a content page at operation 100. The stroke event may initiate scrolling over the content page to alter the content view. The method may further include classifying the stroke event based on characteristics of the stroke event at operation 110, and determining whether to generate a scroll enhancement on the display based on a classification of the stroke event at operation 120.

In some embodiments, certain ones of the operations above may be modified or further amplified as described below. Moreover, in some embodiments additional optional operations may also be included (an example of which is shown in dashed lines in FIG. 6). It should be appreciated that each of the modifications, optional additions or amplifications below may be included with the operations above either alone or in combination with any others among the features described herein. In this regard, for example, the method may further include causing generation of the scroll enhancement only during the scrolling of the content page based on a result of the determining at operation 130. In an example embodiment, classifying the stroke event may include classifying the stroke event as a drag operation or a flick operation. In some cases, classifying the stroke event may further include comparing one or more of a frequency, direction, touch pressure, touch intensity, velocity and length of the stroke event to respective thresholds and classifying the stroke event as major or minor based on a result of the comparing. In some cases, determining whether to generate the scroll enhancement may include determining to generate the scroll enhancement in response to a determination of a major stroke event and not generate the scroll enhancement in response to a determination of a minor stroke event. In some embodiments, causing generation of the scroll enhancement may include causing generation of a semi-transparent scroll enhancement over an edge portion of the content view. In an example embodiment, determining whether to generate the scroll enhancement may include determining whether to generate a vertical scroll bar or horizontal scroll bar based on a direction of the stroke event. In some cases, determining whether to generate the scroll enhancement may include determining whether to generate a vertically oriented scroll shortcut or horizontally oriented scroll shortcut based on a direction of the stroke event.

In an example embodiment, an apparatus for performing the method of FIG. 6 above may comprise a processor (e.g., the processor 70) configured to perform some or each of the operations (100-130) described above. The processor may, for example, be configured to perform the operations (100-130) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-130 may comprise, for example, the scroll manager 80. Additionally or alternatively, at least by virtue of the fact that the processor 70 may be configured to control or even be embodied as the scroll manager 80, the processor 70 and/or a device or circuitry for executing instructions or executing an algorithm for processing information as described above may also form example means for performing operations 100-130.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of a stroke event at a display generating a content view of at least a portion of a content page, the stroke event initiating scrolling over the content page to alter the content view;
classifying the stroke event based on characteristics of the stroke event; and
determining whether to generate a scroll enhancement on the display based on a classification of the stroke event.

2. The method of claim 1, wherein classifying the stroke event comprises classifying the stroke event as a drag operation or a flick operation.

3. The method of claim 1, wherein classifying the stroke event further comprises:
comparing one or more of a frequency, direction, touch pressure, touch intensity, velocity and length of the stroke event to respective thresholds; and
classifying the stroke event as major or minor based on a result of the comparing.

4. The method of claim 3, wherein determining whether to generate the scroll enhancement comprises determining to generate the scroll enhancement in response to a determination of a major stroke event and not generate the scroll enhancement in response to a determination of a minor stroke event.

5. The method of claim 1, further comprising causing generation of the scroll enhancement only during the scrolling of the content page based on a result of the determining.

6. The method of claim 5, wherein causing generation of the scroll enhancement comprises causing generation of a semi-transparent scroll enhancement over an edge portion of the content view.

7. The method of claim 1, wherein determining whether to generate the scroll enhancement comprises determining whether to generate a scroll bar oriented based on a direction of the stroke event.

8. The method of claim 1, wherein determining whether to generate the scroll enhancement comprises determining whether to generate a scroll shortcut oriented based on a direction of the stroke event.

9. An apparatus comprising at least one processor and at least one memory including computer program code, the at least one memory and the computer program code configured to, with the at least one processor, cause the apparatus at least to:
receive an indication of a stroke event at a display configured to generate a content view of at least a portion of a content page, the stroke event configured to initiate scrolling over the content page to alter the content view;
classify the stroke event based on characteristics of the stroke event; and
determine whether to generate a scroll enhancement on the display based on a classification of the stroke event.

10. The apparatus of claim 9, wherein the at least one memory and computer program code are configured to, with the at least one processor, cause the apparatus to classify the stroke event by classifying the stroke event as a drag operation or a flick operation.

11. The apparatus of claim 9, wherein the at least one memory and computer program code are configured to, with the at least one processor, cause the apparatus to classify the stroke event by:
comparing one or more of a frequency, direction, touch intensity, touch pressure, velocity and length of the stroke event to respective thresholds; and
classifying the stroke event as major or minor based on a result of the comparing.

12. The apparatus of claim 11, wherein the at least one memory and computer program code are configured to, with the at least one processor, cause the apparatus to determine whether to generate the scroll enhancement by determining to generate the scroll enhancement in response to a determination of a major stroke event and not generate the scroll enhancement in response to a determination of a minor stroke event.

13. The apparatus of claim 9, wherein the at least one memory and computer program code are further configured to, with the at least one processor, cause the apparatus to cause generation of the scroll enhancement only during the scrolling of the content page based on a result of the determining.

14. The apparatus of claim 13, wherein the at least one memory and computer program code are configured to, with the at least one processor, cause the apparatus to cause generation of the scroll enhancement by causing generation of a semi-transparent scroll enhancement over an edge portion of the content view.

15. The apparatus of claim 9, wherein the at least one memory and computer program code are configured to, with the at least one processor, cause the apparatus to determine whether to generate the scroll enhancement by determining whether to generate a scroll bar oriented based on a direction of the stroke event.

16. The apparatus of claim 9, wherein the at least one memory and computer program code are configured to, with the at least one processor, cause the apparatus to determine whether to generate the scroll enhancement by determining whether to generate a scroll shortcut oriented based on a direction of the stroke event.

17. The apparatus of claim 9, wherein the apparatus is a mobile terminal and further comprises user interface circuitry configured to facilitate user control of at least some functions of the mobile terminal.

18. A computer program product comprising at least one computer-readable storage medium having computer-executable program code instructions stored therein, the computer-executable program code instructions including program code instructions for:
receiving an indication of a stroke event at a display configured to generate a content view of at least a portion of a content page, the stroke event configured to initiate scrolling over the content page to alter the content view;
classifying the stroke event based on characteristics of the stroke event; and
determining whether to generate a scroll enhancement on the display based on a classification of the stroke event.

19. The computer program product of claim 18, further comprising program code instructions for causing generation of the scroll enhancement only during the scrolling of the content page based on a result of the determining.

20. The computer program product of claim 18, wherein program code instructions for causing generation of the scroll enhancement comprises causing generation of a semi-transparent scroll enhancement over an edge portion of the content view.
